(19) United States
(12) Patent Application Publication
(10) Pub. No.: US 2010/0052383 A1
(43) Pub. Date: Mar. 4, 2010

(54) Means of attaching an abductor to a child safety seat

(76) Inventor: Barbara Geraldine Merritt, Indianapolis, IN (US)

Correspondence Address: Barbara G. Merritt, 8311 Gallant Fox Dr., Indianapolis, IN, 46217, US

(21) Appl. No.: 12/231,570

(22) Filed: Sep. 3, 2008

(51) Int. Cl. A47D 1/10; A47D 15/00; B23P 19/04

(52) U.S. Cl. 297/250.1; 297/467; 29/700

(57) ABSTRACT

A child safety seat, for use in a vehicle, where it comprises at least a seat section and a length of webbing connecting a buckle to the seat section of the child safety seat. An abductor, whose function is to keep the user's legs separated, has its proximal end attached through a loop in the buckle's webbing by means of a flap with one end attached to the abductor. In addition, there is a cover, covering the seat portion of the child safety seat with the cover having a flap of material with one edge attached to it in a position that allows the flap to attach to the distal end of the abductor. These two attachments allow the abductor to be held securely against the top side of the seat portion of the child safety seat, restricting movement in any direction.

### BACKGROUND OF THE INVENTION

1. Field of the Invention

The present invention relates to child safety seats for children with disabilities and, more particularly, to a means of effectively attaching an abductor to a child safety seat without the use of a rigid connector.

2. Description of the Background of the Invention

For many years wheel chair bound children with various neuro muscular disorders have benefited from the placement of an abductor (sometimes referred to as a “pommel”) between their legs. The purpose of this device is to restrict involuntary inward movement of the child's legs; since such movement can result in sustained interaction between the legs; causing irritation, bed sores and poor positioning of the pelvis. To mitigate this problem, various configurations of abductors have been in existence for many years and are successfully used as optional equipment on wheel chairs, where they are generally attached by a rigid connector (See FIGS. 1-4 of U.S. Pat. No. 6,286,904 by Obertelli and Harnois).

However, with the increasing prevalence of children with physical handicaps being transported in motor vehicles using large child safety seats, at least two manufacturers, Columbia Medical and Britax Child Safety, have begun selling abductors as optional equipment for these devices as well. The Columbia 2000 features an abductor which is attached in the same manner that abductors are attached to wheel chairs, using a pivoting rigid connector. It uses a locking mechanism designed to securely hold the abductor in place (See FIG. 1). It can be unlocked and pivoted out of the way for removal or placement of the child (See FIG. 2). While the Columbia abductor successfully keeps the user's legs apart, it is sub optimal for the following reasons:

The rigid connector adds significant weight to a child restraint, which makes it more difficult to transfer from one vehicle to another.

The Columbia 2000 has three abductor designs, depending on whether the user uses the long seat extension, short seat extension, or no seat extension at all. Therefore, a child who starts using the safety seat at a relatively young age and needs to use an abductor, is required to purchase three abductors as she grows through the height and weight range of the seat. Furthermore, an additional material cover has to be purchased for each seat extension option. This system results in confusion and unnecessary costs to the consumer.

An abductor mounted with a rigid connector also costs considerably more to manufacture and install than the present invention.

The rigid connector consists of two moving parts: a hinge and a mechanism designed to lock the abductor in place. These mechanisms are subject to wear and tear, as well as malfunction.

Because a rigid connector attaches to the front of the child safety seat, it is impractical to use a front mounted a-lock adjuster to adjust harness length. A front mounted a-lock adjuster is much simpler to use than the harness adjustment system necessary when using an abductor mounted with a rigid connector.

Britax Child Safety attempts to solve the stated problems by providing a rather simple abductor that consists of a triangularly shaped piece of polyurethane foam enclosed by a material covering. Rather than a rigid connector, it is attached via a loop of material sewn to the proximal end (nearest the crotch area of the child) of the abductor. This loop is designed such that the buckle is passed through it and connected to the harness system. Unfortunately, there are two problems with the attachment method. First of all, the loop of material is subject to vertical displacement, allowing the proximal end of the abductor to move out of position. In addition, there is no connection point for the distal end of the abductor, resulting in this end lifting upwards as the child squeezes his legs together (See FIG. 3). The result is that the abductor is frequently (depending on the child) out of position, unable to serve its intended function of keeping the user's legs apart.

### SUMMARY OF THE INVENTION

Therefore, it is an object of the present invention to overcome the previously mentioned problems and to determine a method for effectively positioning an abductor on a child safety seat without the use of a rigid connector.

The invention is a child safety seat, for use in a vehicle, having at least a seat portion, a buckle assembly, and an abductor designed to keep the user's legs apart. In addition, the seat section is covered with a material cover with one edge of a cover flap sewn to it in a location between the user's legs.

The function of the cover flap is to hold down the distal end of the abductor by passing it through a loop having both ends attached to the bottom side of the abductor. The narrow or proximal end of the abductor, nearest to the crotch area of the user, is held in place by passing an abductor flap, with one end connected to the abductor, through a loop sewn in the buckle webbing. The abductor flap is then attached to the material cover that encloses abductor. The extra loop sewn into the webbing makes this attachment point of the prior art more effective by restricting upward movement of the proximal end of the abductor. Taken together, the two attachment points previously described serve to securely hold the abductor flat against the seating surface of the child safety seat, enabling it to effectively restrict inward movement of the user's legs without the use of a rigid connector.

### BRIEF DESCRIPTION OF THE DRAWINGS

FIG. 1 is an elevated perspective view of the front of the Columbia 2000 child safety seat with the abductor rigidly attached.

FIG. 2 is an elevated perspective view of the front of the Columbia 2000 child safety seat with the abductor pivoted out of the way for installing or removing the user.

FIG. 3 is an elevated perspective view of the Britax Traveller Plus child safety seat with the abductor attached to the buckle webbing, which is the only point of attachment.

FIG. 4 is an elevated perspective view of the assembly of the invention with a user installed.

FIG. 5 is an elevated perspective view of the child safety seat of the invention.

FIG. 6 is an elevated perspective view of the child safety seat of the invention.

FIG. 7 is a front elevational view of the buckle assembly of the invention.

FIG. 8 is a left side elevational view of the buckle assembly of the invention.

FIG. 9 is an elevated perspective view of the abductor of the invention.

FIG. 10 is an elevated perspective view of the abductor of the invention.

FIG. 11 is a rear perspective view of the abductor of the invention.

FIG. 12 is an inverted right side perspective view of the abductor of the invention.

FIG. 13 is a bottom plan view of the abductor of the invention.

FIG. 14 is an elevated perspective view of the assembly of the invention.

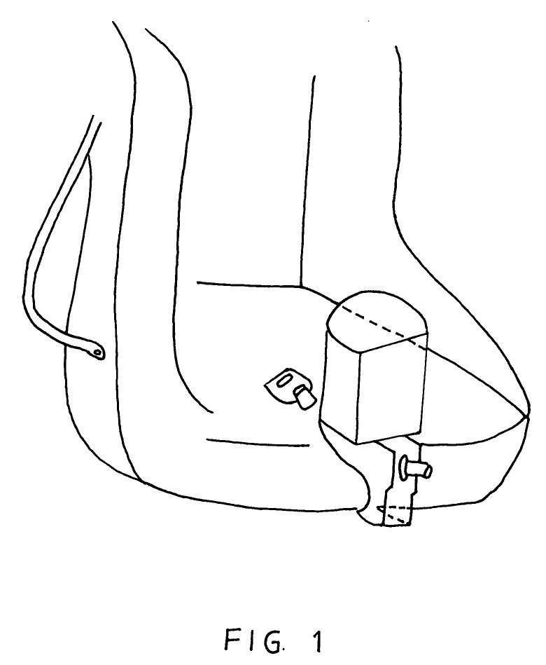

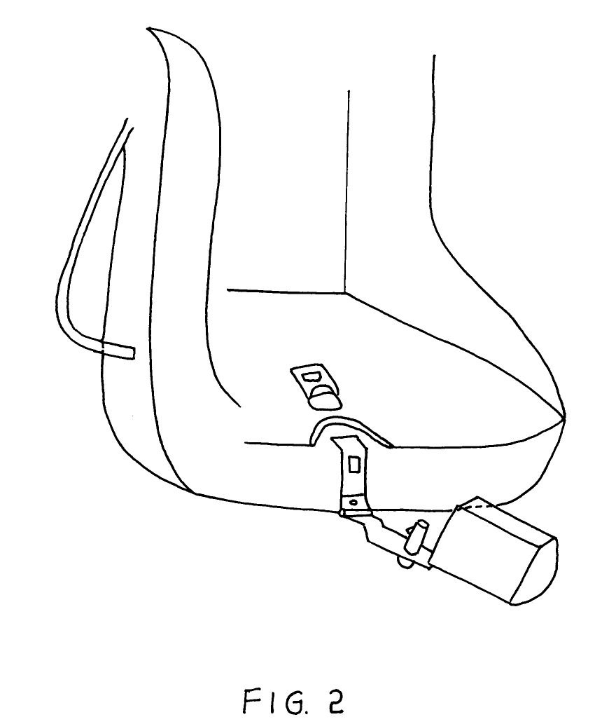

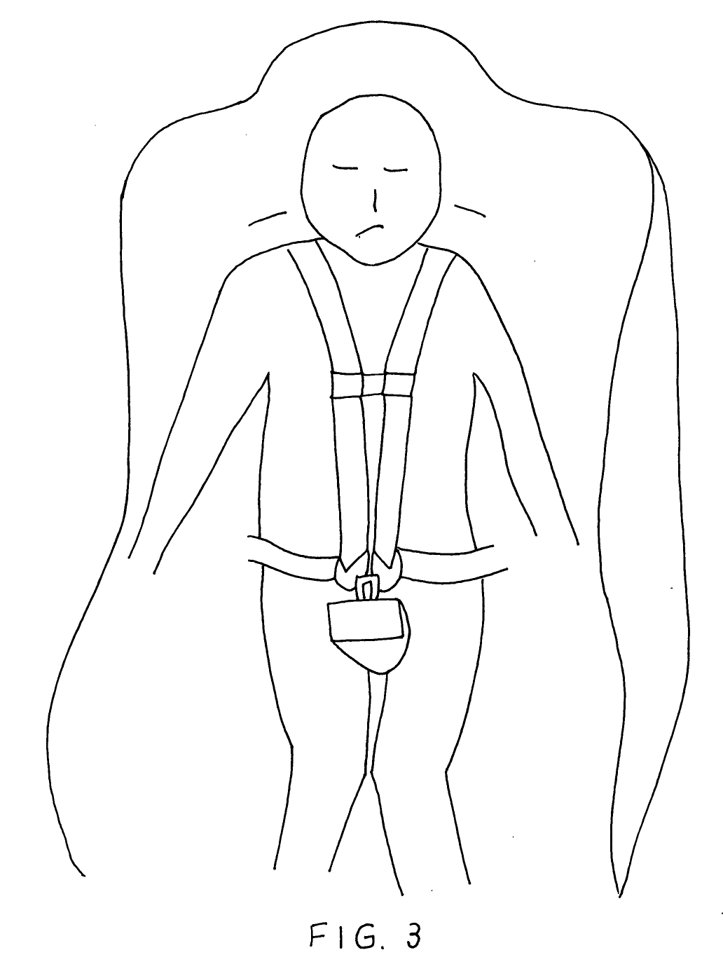

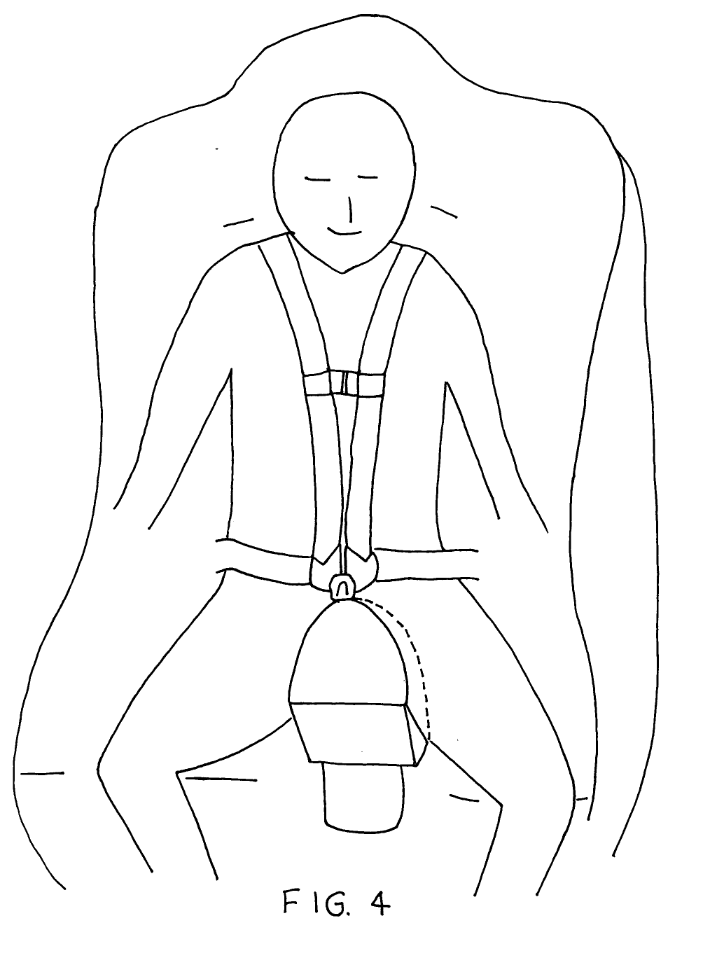

### DETAILED DESCRIPTION OF INVENTION

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

With reference to the Figures, a child safety seat 10 for use in a vehicle is generally shown and includes a shell 20 that has a seat section 21 adapted to support a user thereon. The shell 20 may be press molded from plastic or formed from another rigid or flexible material using means known by skilled artisans. The child safety seat 10 includes a material cover 22 to make the seat comfortable and aesthetically pleasing.

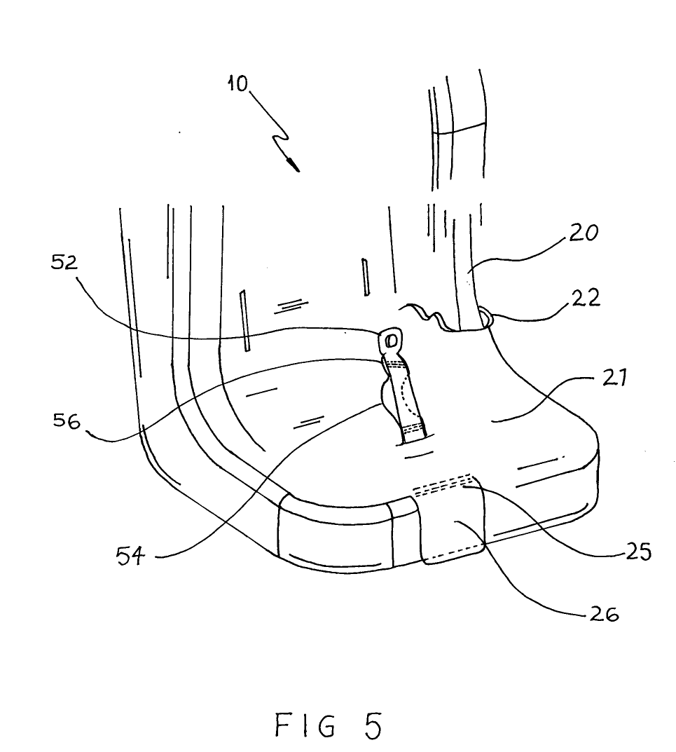

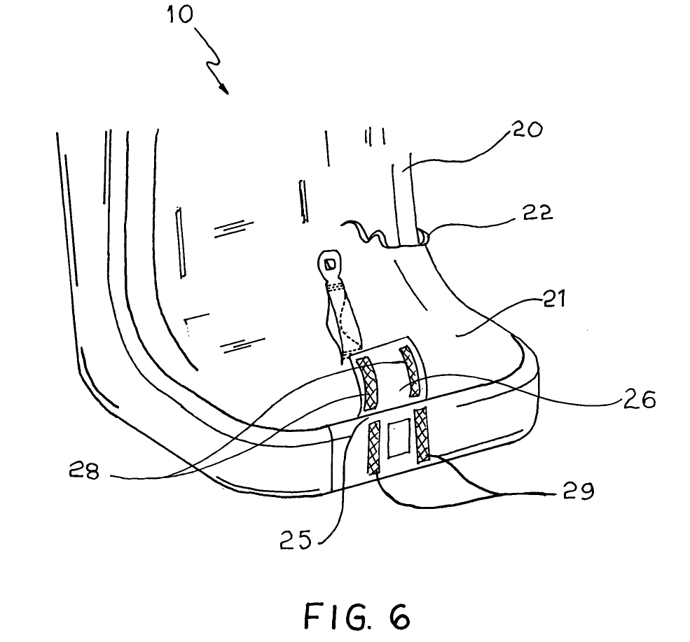

With reference to FIGS. 5 and 6, an edge 25 of a cover flap 26 is sewn to the material cover 22. The cover flap 26 has two strips of hook fastening tape 28 sewn to its underside. Two strips of loop fastening tape 29 are sewn to the upper surface of the material cover 22, positioned such that they will “mate” with the hook fastening tape 28 when the cover flap 26 is closed as in FIG. 5.

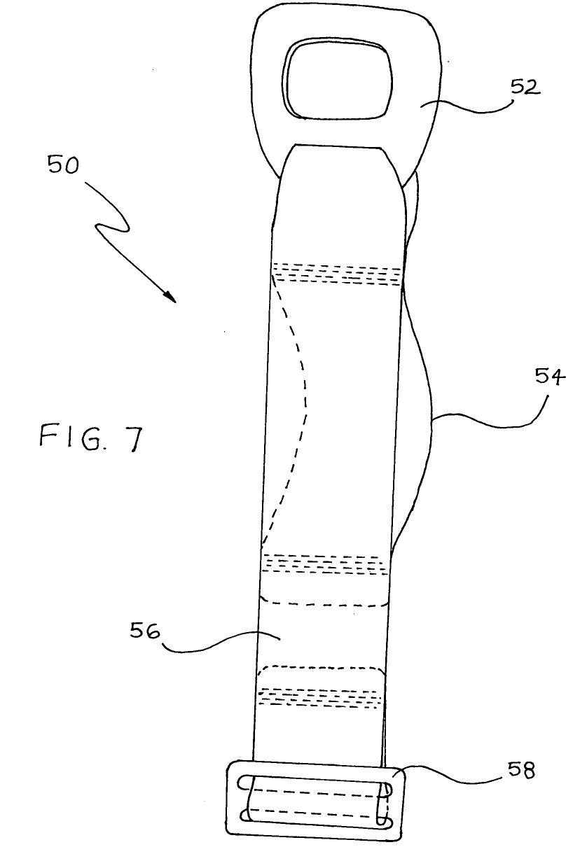

With reference to FIGS. 5, 7 and 8, a buckle assembly 50 includes a length of webbing 56 connecting a buckle 52 to a buckle anchor 58, which anchors the buckle assembly to the seat section 21. The webbing 56 has a webbing loop 54 sewn into it.

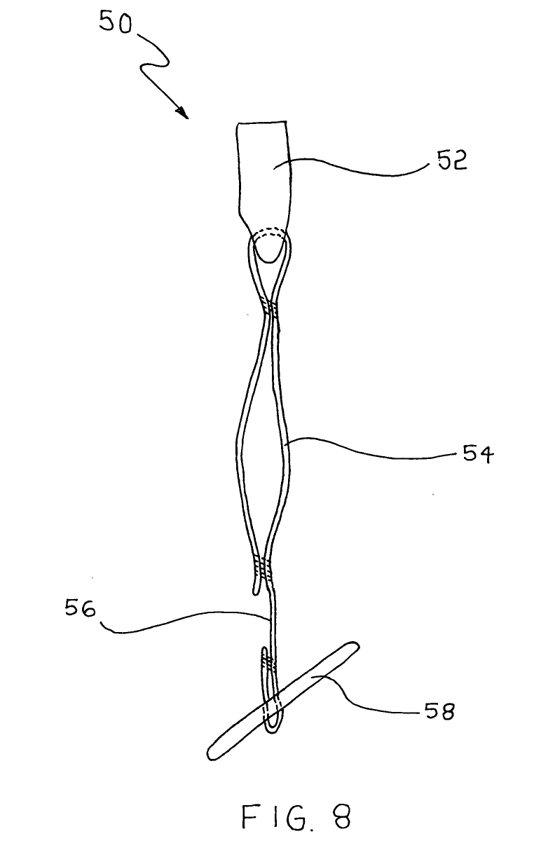

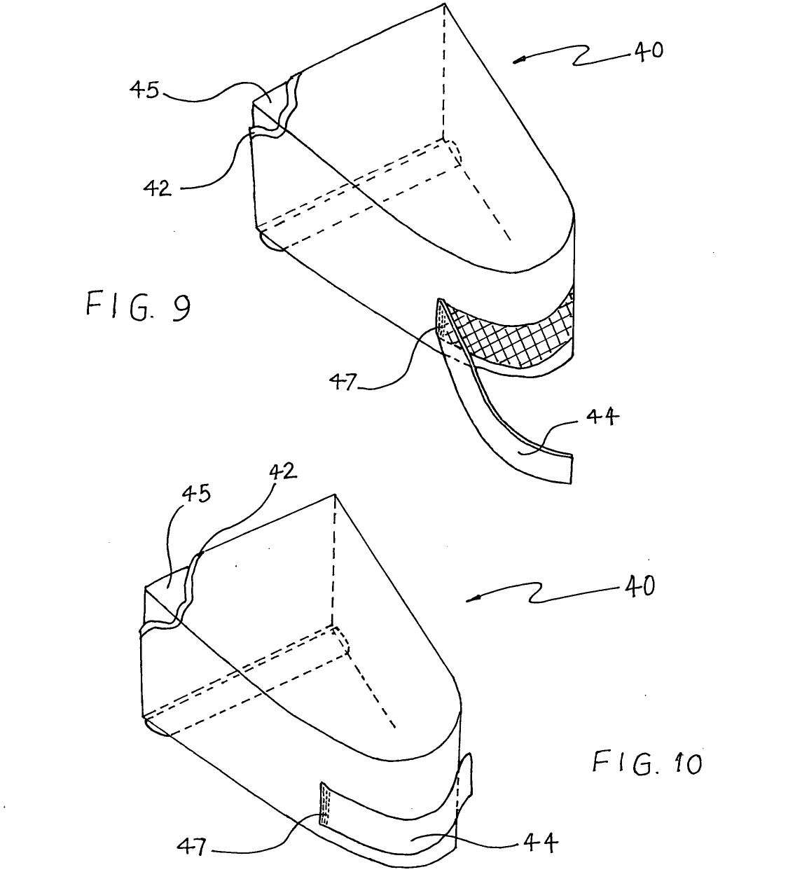

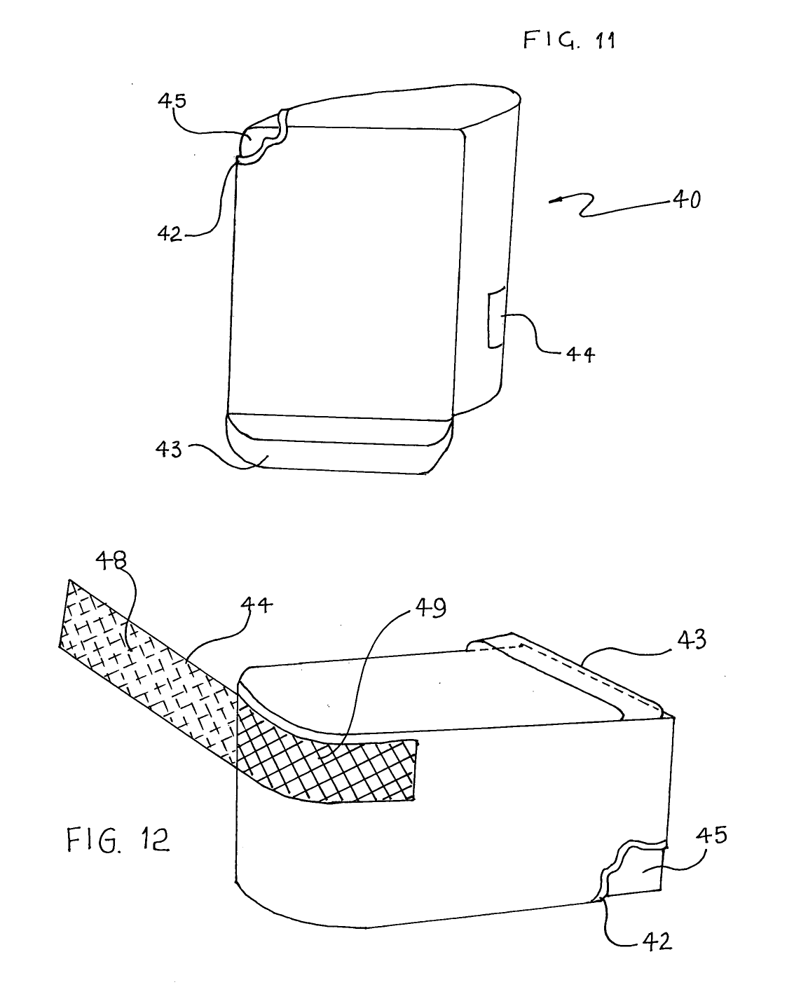

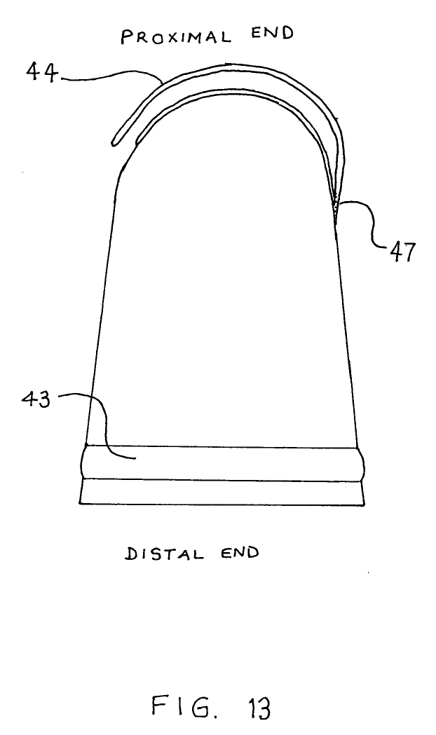

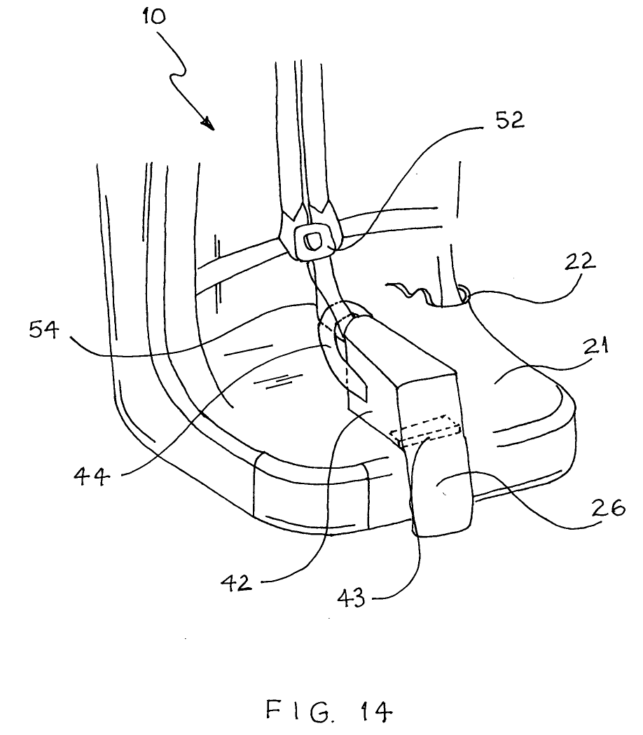

With reference to FIGS. 9, 10, 11, 12, and 13, the abductor 40 includes a material abductor cover 42 and a foam insert 45. With reference to FIG. 9, one edge 47 of an abductor flap 44 is sewn to one side of the proximal end of the abductor cover 42. With reference to FIG. 12, the inner side of the abductor flap 44 has a strip of loop fastening tape 48 sewn to it. A strip of hook fastening tape 49 is sewn to the proximal end of the abductor cover 42, positioned such that it will “mate” with the loop fastening tape 48 when the abductor flap 44 is closed as in FIG. 10.

With reference to FIG. 11, 12, and 13, the distal end of the abductor 40 has an abductor loop 43 with each end sewn to the bottom side of the abductor cover 42, leaving an opening between the bottom side of the abductor cover 42 and the abductor loop 43.

The method for securing the abductor 40 to the seat section 21 of a child safety seat 10 is described below.

With reference to FIGS. 6 and 14, the cover flap 26 is directed through abductor loop 43 and is attached to the material cover 22 by mating the loop 28 and hook 29 fastening tape strips.

With reference to FIGS. 12 and 14, the abductor flap 44 is directed through the webbing loop 54 and is attached to the abductor cover 42, by mating the loop 48 and hook 49 fastening tape strips.

While the invention has been illustrated and described in detail in the drawings and the foregoing description, it is understood that one of ordinary skill in the art could replace the fastening tape with numerous equivalent attachment methods.

What is claimed is:

1. A child safety seat, for use in a vehicle, comprising:
a seat section, adapted to support a user thereon;
a cover, covering said seat section;
a cover flap with one edge attached to said cover such that said cover flap is located between the user's legs;
an abductor designed to keep the user's legs apart;
an abductor loop with each end attached to said abductor, such that said cover flap may be inserted through said abductor loop.

2. A method for securing the distal end of an abductor to the seat section of a child safety seat, said child safety seat including said seat section adapted to support a user thereon, a cover, covering said seat section, a cover flap with one edge attached to said cover such that said cover flap is located between the user's legs, an abductor designed to keep the user's legs apart, an abductor loop with each end attached to said abductor, said method comprising:
placing said abductor, with said abductor loop, on said seat section between the user's legs;
lifting said cover flap and directing said cover flap through said abductor loop;
attaching said cover flap to said cover so that the distal end of said abductor is held securely in place on the top side of said seat section.

3. A child safety seat, for use in a vehicle, comprising:
a seat section, adapted to support a user thereon;
an abductor designed to keep the user's legs apart;
an abductor flap attached to said abductor such that said abductor flap is located against the crotch area of the user.
a child safety seat buckle assembly comprising a child safety seat buckle and a length of webbing with a webbing loop sewn into it such that said abductor flap may be inserted through said webbing loop;

4. A method for securing the proximal end of an abductor to the seat section of a child safety seat, said child safety seat including said seat section adapted to support a user thereon, a child safety seat buckle assembly comprising a child safety seat buckle and a length of webbing with a loop sewn into it, an abductor designed to keep the user's legs apart, an abductor flap attached to said abductor such that said abductor flap is located against the crotch area of the user, said method comprising:
placing said abductor, with said abductor flap, on said seat section between the user's legs;
directing said abductor flap through said loop in said length of webbing;
attaching said abductor flap to said abductor so that the proximal end of said abductor is held securely in place on the top side of said seat section.
